(19) United States
(12) Patent Application Publication
(10) Pub. No.: US 2023/0169640 A1
(43) Pub. Date: Jun. 1, 2023

(54) GROWTH ASSESSMENT SYSTEM, GROWTH ASSESSMENT SERVER AND GROWTH ASSESSMENT METHOD

(71) Applicant: NILEWORKS INC., Tokyo (JP)

(72) Inventors: Chihiro WAKE, Tokyo (JP); Hiroshi YANAGISHITA, Tokyo (JP); Hiroki KATO, Tokyo (JP)

(21) Appl. No.: 17/797,122

(22) PCT Filed: Feb. 6, 2020
(86) PCT No.: PCT/JP2020/004639

§ 371 Date: Aug. 3, 2022

(51) Int. Cl. G06T 7/00; G06V 20/10

(52) U.S. Cl. CPC G06T 7/001; G06V 20/188; G06T 2207/30188

(57) ABSTRACT

Provided are a growth assessment system, growth assessment server and growth assessment method with which it is possible to improve the accuracy of a growth assessment model. A difference determination unit of the growth assessment system compares an estimated growth state value, which is growth state value for a crop that is calculated by a growth assessment model, with a detected growth state value, which is a growth state value for the crop that is calculated based on an image of a field or the crop that is acquired by a camera. A model correction unit corrects the growth assessment model depending on the comparison result from the difference determination unit.

### TECHNICAL FIELD

The present invention relates to a growth assessment system, a growth assessment server and a growth assessment method.

### BACKGROUND ART

In Japanese Patent Application Laid-Open No. 2015-000049 (hereinafter referred to as “JP2015-000049A”), it is a problem to be solved of the disclosed invention to estimate a yield with high accuracy by using aerial photography images and time-series weather data in specific growth stages of a crop, while limiting the number of surveyed farm fields as much as possible (see Abstract). In order to solve this problem, JP2015-000049A (Abstract) discloses that a parameter group serving as a criterion for selecting an actually measured farm field to be surveyed is determined from images of a search region and attribute information of farm fields accumulated in the past, and aerial photography images in which the farm fields as survey targets are photographed. Then, actually measured farm fields are selected so that the parameter group has dispersion as much as possible. Then, candidates of the actually measured farm fields are selected so as to be concentrated as much as possible in order to reduce the burden of survey as much as possible. Further, by analyzing the time-series patterns of the weather data for each growth stage, a parameter group correlated with the growth states is calculated, and a yield estimation using the image feature amount, the attribute information of the farm fields, and the parameter group as explanatory variables is performed.

In JP2015-000049A, a yield estimation model using models such as Formula 3 to Formula 5 is used ([0056] to [0059]).

In Japanese Patent Application Laid-Open No. 2018-082648 (hereinafter referred to as “JP2018-082648A”), it is an object of the disclosed invention, for example, to provide a fertilization design method capable of determining a nitrogen application rate in a farm field more easily than before (Abstract and [0009]). In order to achieve this object, JP2018-082648A (Abstract) discloses that a stage where the leaf color and the number of stems of the growing crop in this term are measured (S31), and the amount of absorbed nitrogen amount of the crop is obtained from the measured leaf color and the measured number of stems (S32), and a stage where by subtracting the amount of nitrogen applied in this term (S33) based on the amount of absorbed nitrogen, the current amount of soil nitrogen is obtained (S34) and a stage where the next-term growth nitrogen application amount for growing the crop in the next term is obtained based on the nitrogen amount in the soil and the appropriate nitrogen amount for growing the crop (S35).

### SUMMARY OF INVENTION

### Problems to be Solved by Invention

As described above, in JP2015-000049A (Abstract), a growth assessment model for performing the yield estimation is used. In addition, in JP2018-082648A (Abstract), a growth assessment model for obtaining the nitrogen application amount for the next term growth is used. However, these growth assessment models have room for improvement in terms of accuracy.

The present invention has been made in consideration of the above problems, and an object of the present invention is to provide a growth assessment system, a growth assessment server, and a growth assessment method capable of improving the accuracy of a growth assessment model.

### Means for Solving the Problems

A growth assessment system according to one aspect of the present invention comprises:

a growth assessment device that assesses a growth state of a crop in a farm field using a growth assessment model;

a camera that acquires an image of the farm field;

a detected growth state value calculation unit that calculates a detected growth state value as a growth state value of the crop based on the image of the farm field;

a difference determination unit that compares the detected growth state value with an estimated growth state value that is a growth state value of the crop calculated by the growth assessment model; and

a model correction unit that corrects the growth assessment model in accordance with the comparison result by the difference determination unit.

According to this aspect of the present invention, the growth assessment model is corrected by comparing the estimated growth state value calculated by the growth assessment model with the detected growth state value based on the image of the farm field acquired by the camera. Thereby, it is possible to perform a growth assessment according to the characteristics of each farm field with the accuracy according to the reliability of the detected growth state value based on the image of the farm field, and thus the accuracy of the growth assessment model can be improved. In addition, by using the image of the farm field, it is possible to easily perform the growth assessment according to the characteristics of each farm field.

The growth state value of the crop may include, for example, the number of grains of the crop, an effective light receiving area ratio which is an area ratio of leaves for photosynthesis in the farm field, or a red light absorbing ratio which is a ratio of red light absorbed by the crop in the image of the farm field. Further, as the growth state value of the crop, an effective light receiving area obtained by multiplying the effective light receiving area ratio by a target area or a red light absorbing amount obtained by multiplying the red light absorbing ratio by the target area can also be used. In those cases, the model correction unit may correct the growth assessment model when an absolute value of difference or difference ratio exceeds a first difference threshold, the absolute value of the difference or the difference ratio may include those between

the estimate number of grains of the crop, an estimated effective light receiving area ratio, an estimated red light absorbing ratio, an estimated effective light receiving area or an estimated red light absorbing amount that are calculated by the growth assessment model, and

the detected number of grains of the crop, a detected effective light receiving area ratio, a detected red light absorbing ratio, a detected effective light receiving area or a detected red light absorbing amount that are calculated by the image of the farm field. Thus, only when necessity of correcting the growth assessment model is high, the correction can be performed.

It is noted that the effective light receiving area ratio herein means the ratio of the leaves (and stems) that perform photosynthesis to the entire image of the farm field. Further, the red light absorbing ratio indicates a ratio in which the wavelength band of red light is absorbed by the crop in the image of the farm field, and is one of indexes showing the amount of chlorophyll for photosynthesis.

The growth assessment system may further include an imaging failure determination unit that determines whether there is an imaging failure by the camera based on the image of the farm field. Further, the detected state value calculation unit may calculate the detected growth state value based on the image of the farm field that the imaging failure determination unit has determined there is no imaging failure. Thereby, it is possible to use the detected growth state value only when there is no imaging failure (that is, when the imaging is normal).

The growth assessment system may further include a re-imaging request unit that requests re-imaging by the camera when the imaging failure determination unit has determined that the imaging failure has occurred. Thereby, the reliability of the growth assessment model can be improved by improving the accuracy of the detected growth state value by the re-imaging.

The imaging failure determination unit may determine whether there is the imaging failure for each farm field or for each partial region included in the farm field. The re-imaging request unit may request the re-imaging for the farm field in which the imaging failure has occurred when occurrence of the imaging failure has been determined. Thereby, it is possible to re-acquire the detected growth state value in units of farm fields.

Alternatively, the imaging failure determination unit may determine whether there is the imaging failure for each partial region included in the farm field. If there is the imaging failure, the re-imaging request unit may request the re-imaging for the partial region in which the imaging failure has occurred. Thereby, it is possible to reduce man-hours by performing re-imaging only for the partial region in which the imaging failure has occurred.

If the imaging failure determination unit determines that the imaging failure has occurred, the re-imaging request unit may request the re-imaging at a time zone or at a solar height different from the previous imaging. Thereby, it is possible to reduce the possibility of re-occurrence of the imaging failure.

If the imaging failure determination unit determines that the imaging failure has occurred, the re-imaging request unit may request the re-imaging in a direction different from the previous imaging in a relative positional relationship between the camera and the sun. Thereby, it is possible to reduce the possibility of re-occurrence of the imaging failure.

If the imaging failure determination unit determines that the imaging failure has occurred, the re-imaging request unit may request the re-imaging in a weather different from the previous imaging. Thereby, it is possible to reduce the possibility of re-occurrence of the imaging failure.

If the imaging failure determination unit determines that the imaging failure has occurred, the re-imaging request unit may request the re-imaging in a direction different from the previous imaging in a relative positional relationship between the camera and the farm field. Thereby, it is possible to reduce the possibility of re-occurrence of the imaging failure.

If the absolute value of the difference or the difference ratio exceeds the first difference threshold, a parameter or a default value of the growth assessment model may be corrected, the absolute value of the difference or the difference ratio being those between the estimate number of grains of the crop, the estimated effective light receiving area ratio, the estimated red light absorbing ratio, the estimated effective light receiving area or the estimated red light absorbing amount that are calculated by the growth assessment model, and the detected number of grains of the crop, the detected effective light receiving area ratio, the detected red light absorbing ratio, the detected effective light receiving area or the detected red light absorbing amount that are calculated by the image of the farm field. Thereby, when the cause of the difference between the estimated growth state value and the detected growth state value is in the parameter or the default value of the growth assessment model, the growth assessment model can be more preferably corrected.

The growth assessment system may further include a drone on which the camera is mounted, and a schedule management unit that manages a schedule of imaging by the drone for comparison between the estimated growth state value and the detected growth state value. If the difference determination unit determines that the absolute value of the difference or the difference ratio between the estimated growth state value and the detected growth state value exceeds the first difference threshold, the schedule management unit may add a new imaging schedule before the next imaging of the initial plan or make the next imaging earlier than the initial plan. Thereby, it is possible to relatively early reconfirm whether there is no difference between the estimated growth state value and the detected growth state value, in other words, whether the reliability of the growth assessment model is high.

If the absolute value of the difference or the difference ratio between the estimated growth state value and the detected growth state value falls below a second difference threshold after the absolute value of the difference or the difference ratio between the estimated growth state value and the detected growth state value exceeds the first difference threshold, the schedule management unit may return the schedule of the imaging to the initial plan. Thereby, when it can be determined that the absolute value of the difference or the difference ratio between the estimated growth state value and the detected growth state value becomes sufficiently small, in other words, when it can be determined that the reliability of the growth assessment model becomes sufficiently high, the imaging timing of the drone can be delayed.

If the absolute value of the difference or the difference ratio between the estimated growth state value and the detected growth state value is lower than a third difference threshold and the growth of the crop is as planned or earlier than planned, the schedule management unit may reduce the number of times of imaging than the initial plan. Thereby, when it can be determined that the difference between the estimated growth state value and the detected growth state value is sufficiently small, in other words, when it can be determined that the reliability of the growth assessment model is sufficiently high, the imaging timing of the drone can be delayed.

If the crop matures earlier than planned, the schedule management unit may advance the timing of the final imaging. Thereby, it possible to avoid imaging at an unnecessary timing.

The schedule management unit may increase the frequency of the imaging at a timing when the amount of change in the growth state value of the crop or the amount of change in the growth state value of the crop per unit period, or the absolute value of the growth state value is larger than a first frequency determination threshold. Thereby, the reliability of the growth assessment system can be easily confirmed at the timing when the amount of change in the growth state value of the crop or the amount of change in the growth state value of the crop per unit period, or the absolute value of the growth state value is large. It should be noted that the term “increase the frequency” here may include any of shortening the minimum schedule interval of the imaging and increasing the number of imaging times in a predetermined period.

The schedule management unit may lower the frequency of the imaging at a timing when the absolute value of the growth state value or the amount of the change in the growth state value per unit period or the absolute value of the change amount of the growth state value is smaller than a second frequency determination threshold. Thereby, it is possible to suppress the imaging frequency of the drone at the timing when the absolute value of the growth state value or the amount of the change in the growth state value per unit period or the absolute value of the change amount of the growth state value is small.

The schedule management unit may switch the first frequency determination threshold or the second frequency determination threshold in accordance with the growth phase of the crop. Thereby, it is possible to switch the imaging frequency in accordance with the growth phase of the crop. Transition-period frequency, which is the imaging frequency by the drone at the transition period of the growth phase of the crop, may be higher than normal frequency, which is a normal value of the imaging frequency at a period other than the transition period of the growth phase of the crop. Maximum frequency at occurrence of difference, which the schedule management unit may set if the difference determination unit determines the absolute value of the difference or the difference ratio between the estimated growth state value and the detected growth state value has exceeded the first difference threshold, may be larger than the transition-period frequency. Thereby, it is possible to increase the imaging frequency when there is the difference between the estimated growth state value and the detected growth state value, and therefore to improve the reliability of the growth assessment system.

The growth assessment system may include a yield sensor that measures a yield as the number of grains or the weight of the harvested crop, and a yield input unit by which a measured yield as the measured number of grains or the measured weight yield is input. Further, the estimated growth state value may include an estimated yield that is the number of grains or the weight of the crop calculated by the growth assessment model. If the measured yield is input via the yield input unit, the model correction unit may compare the measured yield with the estimated yield to correct the growth assessment model. Thereby, if the measured yield is more accurate than the detected yield (or the number of grains or the weight of the crop calculated based on the image), the reliability of the growth assessment system can be improved by preferentially using the result of comparison between the measured yield and the estimated yield.

In a case where the crop is rice, the growth assessment system may include a waste rice ratio measuring device that measures a ratio of immature rice contained in a unit amount of rice after harvesting, and a waste rice ratio input unit by which a measured waste rice ratio, which is a measured value of the waste rice ratio, is input. The estimated growth state value may include an estimated waste rice ratio that is a waste rice ratio calculated by the growth assessment model. If the measured waste rice ratio is input via the waste rice ratio input unit, the model correction unit may compare the measured waste rice ratio with the estimated waste rice ratio to correct the growth assessment model. Thereby, if the measured rice ratio is more accurate than the detected waste rice ratio (or the waste rice ratio calculated based on the image), the reliability of the growth assessment system can be improved by preferentially using the result of comparison between the measured waste rice ratio and the estimated yield waste rice ratio.

A growth assessment server according to another aspect of the present invention that assesses a growth state of a crop by a growth assessment model, comprises:

a detected growth state value calculation unit that calculates a detected growth state value as a growth state value of the crop based on an image of the crop captured by a camera;

a difference determination unit that compares the detected growth state value with an estimated growth state value that is a growth state value of the crop calculated by the growth assessment model; and

a model correction unit that corrects the growth assessment model in accordance with the comparison result by the difference determination unit.

A growth assessment method according to further another aspect of the present invention for assessing a growth state of a crop by a growth assessment model, comprises:

a detected growth state value calculation step of calculating a detected growth state value as a growth state value of the crop based on an image of the crop captured by a camera;

a difference determination step of comparing the detected growth state value with an estimated growth state value that is a growth state value of the crop calculated by the growth assessment model; and

a model correction step of correcting the growth assessment model in accordance with the comparison result by the difference determination step.

### Effect of Invention

According to the present invention, it is possible to improve the accuracy of a growth assessment model.

### BRIEF DESCRIPTION OF DRAWINGS

FIG. 1 is an overall configuration diagram showing an outline of a growth assessment system according to an embodiment of the present invention;

FIG. 2 is a configuration diagram schematically showing a configuration of a growth assessment server according to the embodiment;

FIG. 3 is a configuration diagram schematically showing a configuration of a drone according to the embodiment;

FIG. 4 is a first flowchart showing calibration schedule management control in the embodiment;

FIG. 5 is a second flowchart showing the calibration schedule management control in the embodiment;

FIG. 6 is an explanatory diagram for explaining a determination method of a necessary monitoring status in the embodiment; and

FIG. 7 is a flowchart of calibration execution control in the embodiment.

### DESCRIPTION OF EMBODIMENTS

### A. An Embodiment

### <A-1. Configuration>

### [A-1-1. Overall Configuration]

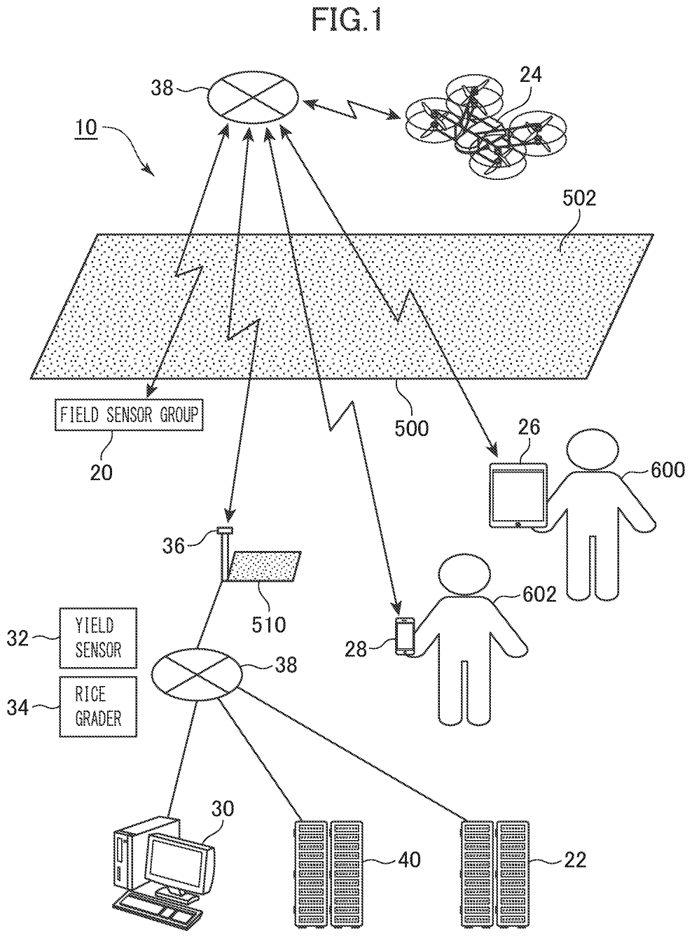

FIG. 1 is an overall configuration diagram showing an outline of a growth assessment system 10 according to an embodiment of the present invention. The growth assessment system 10 (hereinafter also referred to as “system 10”) performs a growth assessment of a crop 502 growing in a farm field 500, while spraying medical agents (including liquid fertilizer) to the crop 502. The crop 502 in the present embodiment are rice (wet-field rice), but may be other crops as described later. The farm field 500 is a paddy field.

As shown in FIG. 1, the system 10 includes a farm field sensor group 20, a growth assessment server 22, a drone 24, a first user terminal 26, a second user terminal 28, a third user terminal 30, a yield sensor 32, and a rice grader 34 (waste rice ratio measuring device). The farm field sensor group 20, the drone 24, the first user terminal 26, and the second user terminal 28 perform wireless communication with each other via a communication network 38 (including a radio base station 36), and communicate with the growth assessment server 22. As the wireless communication, communication that does not go through the wireless base station 36 (for example, LTE (Long Term Evolution), Wi-Fi or the like) can be used. The growth assessment server 22 can also communicate with an information providing server 40 via the communication network 38.

### [A-1-2. Farm Field Sensor Group 20]

The farm field sensor group 20 is installed in the farm field 500 as a paddy field, detects various data in the farm field 500, and provides the data to the growth assessment server 22 or the like. The farm field sensor group 20 includes, for example, a water temperature sensor, a temperature sensor, a precipitation amount sensor, an illuminance meter, an anemometer, an air pressure meter, and a humidity meter. The water temperature sensor detects the water temperature of the farm field 500 as the paddy field. The temperature sensor detects the air temperature of the farm field 500. The precipitation amount sensor detects a precipitation amount in the farm field 500. The illuminance meter detects the amount of sunshine in the farm field 500. The anemometer detects the wind speed in the farm field 500. The air pressure meter detects the air pressure in the farm field 500. The humidity meter detects the humidity in the farm field 500. Some of the values of these sensors may be obtained from the information providing server 40.

### [A-1-3. Growth Assessment Server 22]

### (A-1-3-1. Outline)

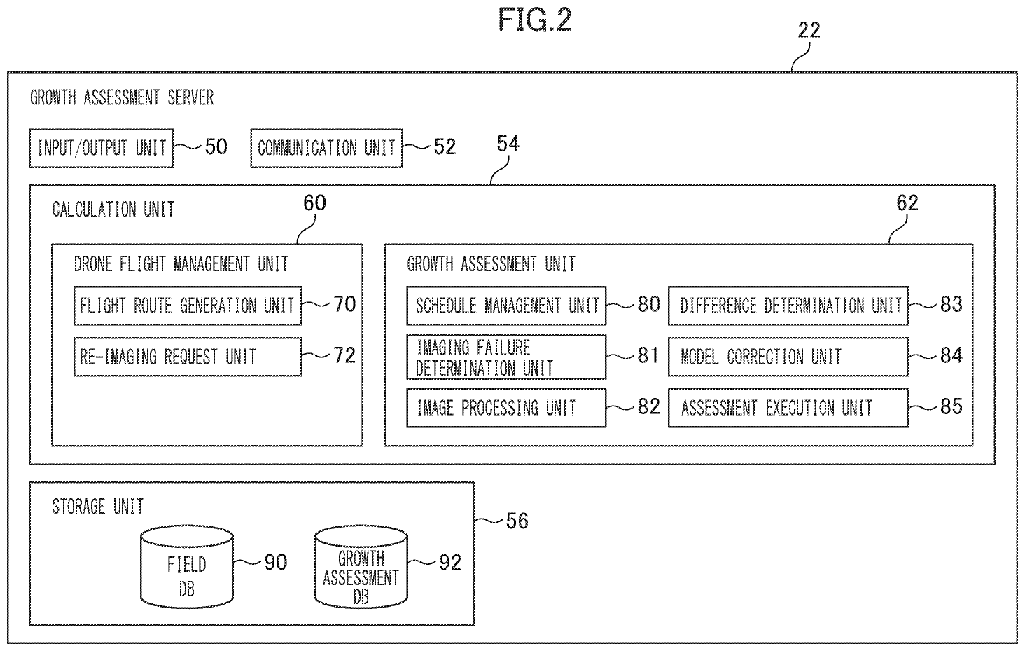

FIG. 2 is a configuration diagram schematically showing a configuration of the growth assessment server 22 according to the present embodiment. The growth assessment server 22 (hereinafter also referred to as “assessment server 22”) performs a growth assessment (growth diagnosis) using a growth assessment model, and provides work instructions to a user based on the assessment result. The work instructions include instructions regarding fertilization timing, type and amount of a fertilizer, spraying timing of agricultural chemicals, and type and amount of the agricultural chemicals and the like.

As shown in FIG. 2, the assessment server 22 includes an input/output unit 50, a communication unit 52, a calculation unit 54, and a storage unit 56. The communication unit 52 includes a modem or the like (not shown). The communication unit 52 can communicate with the farm field sensor group 20, the drone 24, the first user terminal 26, the second user terminal 28, the third user terminal 30, and the information providing server 40 or the like via the communication network 38.

The calculation unit 54 includes a central processing unit (CPU) and operates by executing programs stored in the storage unit 56. Some of the functions executed by the calculation unit 54 may be realized by using a logic IC (Integrated Circuit). The calculation unit 54 may be configured by hardware (circuit components) for a part of the programs. The same applies to a calculation unit of the drone 24 etc., which will be described later.

The storage unit 56 stores the programs and the data used by the calculation unit 54, and includes a random access memory (hereinafter referred to as “RAM”). As the RAM, a volatile memory such as a register and a nonvolatile memory such as a hard disk or a flash memory can be used. Further, the storage unit 56 may have a read-only memory (ROM) in addition to the RAM. The same applies to a storage unit of the drone 24 etc., which will be described later.

### (A-1-3-2. Calculation Unit 54)

As shown in FIG. 2, the calculation unit 54 includes a drone flight management unit 60 and a growth assessment unit 62. The drone flight management unit 60 manages flight (route, etc.) of the drone 24. The growth assessment unit 62 performs a growth assessment using a growth assessment model.

The drone flight management unit 60 includes a flight route generation unit 70 and a re-imaging request unit 72. The flight route generation unit 70 generates a flight route of the drone 24. If an imaging failure determination unit 81 (described later) determines that the imaging by the drone 24 is not normal, the re-imaging request unit 74 requests re-imaging by the drone 24.

The growth assessment unit 62 includes a schedule management unit 80, an imaging failure determination unit 81, an image processing unit 82, a difference determination unit 83, a model correction unit 84, and an assessment execution unit 85. The schedule management unit 80 manages the calibration schedule of the growth assessment model. The imaging failure determination unit 81 determines an imaging failure by the drone 24 at the time of the calibration. The image processing unit 82 processes an image captured by the drone 24 to calculate a growth state value V of the crop 502 (detected growth state value Vd). The difference determination unit 83 compares an estimated growth state value Ve, which is the growth state value V of the crop 502 calculated by the growth assessment model, with the detected growth state value Vd, and determines the difference between both. The model correction unit 84 corrects the growth assessment model in accordance with the comparison result by the difference determination unit 83. The assessment execution unit 85 executes growth assessment control.

### (A-1-3-3. Storage Unit 56)

The storage unit 56 stores the programs and the data used by the calculation unit 54 to realize the drone flight management unit 60, the growth assessment unit 62, and the like, and includes a farm field database 90 (hereinafter referred to as “field DB 90”) and a growth assessment database 92 (hereinafter referred to as “growth assessment DB 92”). The field DB 90 stores information for each farm field 500 necessary for flight of the drone 24 (farm field information for flight). The farm field information for flight includes, for example, the position information of the fields 500. The growth assessment DB 92 stores various types of information related to the growth assessment (growth assessment information). The growth assessment information includes, for example, growth assessment schedules, past assessment results (including the type of crops 502 cultivated in the past, yields Q, and waste rice ratios R), and growth assessment models (such as parameters including coefficients and default values)), and image data (images of the farm fields 500).

### [A-1-4. Drone 24]

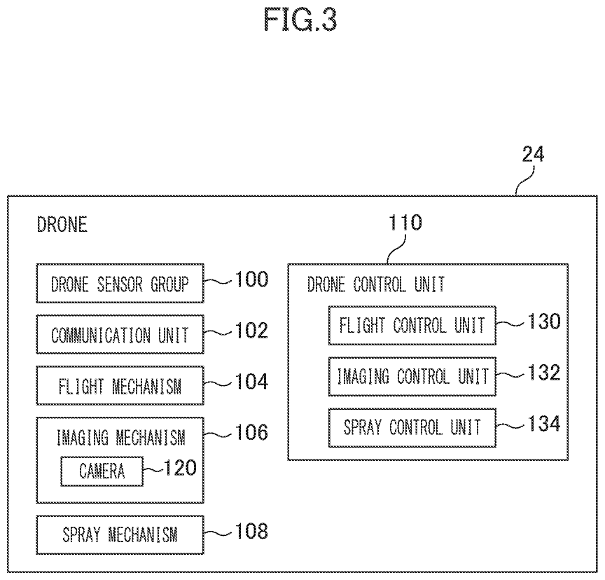

FIG. 3 is a configuration diagram schematically showing a configuration of the drone 24 according to the present embodiment. In the present embodiment, the drone 24 functions as a means for acquiring farm field images for calibration of the growth assessment model and also functions as a means for spraying medicinal solutions (including liquid fertilizer) to the crop 502. The drone 24 takes off and lands on a departure and arrival point 510 (FIG. 1).

As shown in FIG. 3, the drone 24 includes a drone sensor group 100, a communication unit 102, a flight mechanism 104, an imaging mechanism 106, a spray mechanism 108, and a drone control unit 110.

The drone sensor group 100 includes a global positioning system sensor (hereinafter referred to as “GPS sensor”), a speedometer, an altimeter, a gyro sensor, a liquid amount sensor (none of which are shown), and the like. The GPS sensor outputs the current position information of the drone 24. The speedometer detects the flight speed of the drone 24. The altimeter detects the ground altitude as a distance to the ground below the drone 24. The gyro sensor detects the angular velocity of the drone 24. The liquid amount sensor detects the amount of liquid in a tank of the spray mechanism 108.

The communication unit 102 can perform radio wave communication via the communication network 38, and includes, for example, a radio wave communication module. The communication unit 102 can communicate with the growth assessment server 22, the first user terminal 26, and the second user terminal 28 and the like via the communication network 38 (including the radio base station 36).

The flight mechanism 104 is a mechanism that flies the drone 24, and includes a plurality of propellers and a plurality of propeller actuators. Each propeller actuator has, for example, an electric motor.

The imaging mechanism 106 is a mechanism that captures an image of the farm field 500 or the crop 502 (hereinafter also referred to as “drone image” or “farm field image”), and includes a camera 120. The camera 120 of the present embodiment is a multi-spectral camera, and particularly acquires an image capable of analyzing the growth state of the crop 502. The imaging mechanism 106 further include an irradiation unit that irradiates the farm field 500 with a light beam having a specific wavelength, and may receive a reflected light from the field 500 with respect to the light beam. The light beam having the specific wavelength may be, for example, red light (about 650 nm in wavelength) and near infrared light (about 774 nm in wavelength). By analyzing the reflected light of the light beam, the nitrogen absorbing amount of the crop 502 can be estimated, and the growth state of the crop 502 can be analyzed based on the estimated nitrogen absorbing amount.

The camera 120 is arranged at a lower portion of a body of the drone 24 and outputs image data related to a peripheral image obtained by imaging the periphery of the drone 24. The camera 120 is a video camera that captures a moving image. Alternatively, the camera 120 may capture both a moving image and a still image or only the still image.

The orientation of the camera 120 (the posture of the camera 120 with respect to the main body of the drone 24) can be adjusted by a camera actuator (not shown). Alternatively, the position of the camera 120 with respect to the main body of the drone 24 may be fixed.

The spray mechanism 108 is a mechanism that sprays medical agents (including liquid fertilizer), and includes, for example, a medical agent tank, a pump, a flow control valve, and a medical agent nozzle.

The drone control unit 110 controls the entire drone 24 such as flight, imaging, and spraying of the medical agents of the drone 24. The drone control unit 110 includes an input/output unit, a calculation unit, and a storage unit (not shown). The drone control unit 110 includes a flight control unit 130, an imaging control unit 132, and a spray control unit 134. The flight control unit 130 controls the flight of the drone 24 via the flight mechanism 104. The imaging control unit 132 controls imaging by the drone 24 via the imaging mechanism 106. The spray control unit 134 controls the spraying of the medical agents by the drone 24 via the spray mechanism 108.

### [A-1-5. First User Terminal 26]

The first user terminal 26 is a portable information terminal that controls the drone 24 by the operation of a user 600 (FIG. 1) as an operator in the farm field 500, and displays information received from the drone 24 (for example, the position, the amount of the medical agent, the battery level and a camera image, and the like). In the present embodiment, the flight state (altitude, posture, etc.) of the drone 24 is not remotely controlled by the first user terminal 26, but the drone 24 autonomously controls the flight state. Therefore, when a flight command is transmitted from the user 600 to the drone 24 via the first user terminal 26, the drone 24 performs autonomous flight. However, manual operation may be performed at the time of basic operation such as takeoff and return and at the time of emergency. The first user terminal 26 includes an input/output unit (including a touch panel or the like), a communication unit, a calculation unit and a storage unit (not shown), and is composed of, for example, a general tablet terminal.

Further, the first user terminal 26 of the present embodiment receives and displays work instructions or the like from the growth assessment server 22.

### [A-1-6. Second User Terminal 28]

The second user terminal 28 is a portable information terminal used by a user 602 (FIG. 1) other than the operator in the field 500, receives flight information of the drone 24 (current flight situation, flight end scheduled time, etc.), work instructions for the user 602, information on the growth assessment, and the like from the assessment server 22 or the drone 24 and displays the information. The second user terminal 28 includes an input/output unit (including a touch panel or the like), a communication unit, a calculation unit, and a storage unit (not shown), and is composed of, for example, a general smartphone.

### [A-1-7. Third User Terminal 30]

The third user terminal 30 is a terminal used by the users 600, 602 or the like to utilize the growth assessment by the growth assessment server 22 in a place other than the farm field 500 (for example, a company to which the users 600, 602 or the like belong). The third user terminal 30 includes an input/output unit (including, for example, a keyboard and a display unit), a communication unit, a calculation unit, and a storage unit (not shown), and is composed of, for example, a desktop personal computer (PC) or a notebook PC.

### [A-1-8. Yield Sensor 32]

The yield sensor 32 is a device that measures the yield Q of the harvested crop 502. The yield Q here is the number of grains of the harvested crop 502 (wet-field rice). Alternatively, the yield Q may be the weight of the harvested crop 502. The yield sensor 32 is positioned, for example, in a warehouse (not shown) that stores the crop 502 after harvesting. Alternatively, the yield sensor 32 may be provided on a combine (not shown) for harvesting.

In the present embodiment, the yield Q measured by the yield sensor 32 (hereinafter also referred to as “measured yield Qm”) is input by the third user terminal 30, and is transmitted to the growth assessment server 22 together with the ID of the farm field 500. Alternatively, if the yield sensor 32 has a network communication function, the measured yield Qm may be automatically transmitted to the growth assessment server 22 via the communication network 38. It should be noted that the measurement of the yield Q using the yield sensor 32 includes not only the harvesting of the whole field 500 (harvesting in the entire field 500), but also a case in which only a part of the field 500 is harvested and measured as the yield Q of the crop 502.

### [A-1-9. Rice Grader 34]

The rice grader 34 (waste rice ratio measuring device) is a device that measures a waste rice ratio R of the crop 502 (paddy rice) after harvesting. The waste rice ratio R is a ratio of immature rice (for example, rice passing through a sieve having a mesh width of 1.7 mm) contained in the crop 502 per unit amount. The rice grader 34 is placed, for example, in a warehouse (not shown) that stores the post-harvest crop 502. In the present embodiment, the waste rice ratio R measured by the rice grader 34 (hereinafter also referred to as “measured waste rice ratio Rm”) is input by the third user terminal 30 together with the ID of the farm field 500 and transmitted to the growth assessment server 22. Alternatively, if the rice grader 34 has a network communication function, the measured waste rice ratio Rm may be automatically transmitted to the growth assessment server 22 via the communication network 38.

### [A-1-10. Information Providing Server 40]

The information providing server 40 provides information related to the farm field 500 (farm field information) obtained by a weather satellite or the like to the growth assessment server 22. The farm field information herein includes, for example, a temperature, a precipitation amount, and the like of the field 500.

### <A-2. Controls of the Present Embodiment>

### [A-2-1. Outline]

In the growth assessment system 10 of the present embodiment, growth assessment control, drone flight management control, and growth assessment model calibration management control are performed. The growth assessment control is control for performing the growth assessment of the crop 502 based on various detected values from the field sensor group 20 and the like. The drone flight management control is control for managing flight of the drone 24 in the farm field 500 for the growth assessment control, the growth assessment model calibration management control, and the like. The growth assessment model calibration management control is control for performing calibration of the growth assessment model.

### [A-2-2. Growth Assessment Control]

As described above, the growth assessment control is control for performing the growth assessment of the crop 502 based on the various detected values from the farm field sensor group 20, and mainly executed by the growth assessment server 22 (particularly, the assessment execution unit 85 of the growth assessment unit 62). The growth assessment here includes, for example, calculation and presentation of an estimated value of yield Q (estimated yield Qe) for each field 500, and calculation and provision of the time of each growth phase of the crop 502 for each field 500. Further, in the growth assessment control, work instructions related to fertilization, medical agent spraying, or the like are also provided. The work instructions are displayed on the display unit of the first user terminal 26, the second user terminal 28 or the third user terminal 30, for example.

As the growth assessment control, those described in JP2015-000049A or JP2018-082648A can be used, for example.

### [A-2-3. Drone Flight Management Control]

As described above, the drone flight management control is control for managing the flight of the drone 24 in the farm field 500 for the growth assessment control, the growth assessment model calibration management control, and the like, and is mainly executed by the growth assessment server 22 (particularly, the drone flight management unit 60). Specifically, in the drone flight management control, a flight path, a target speed, a target altitude, and the like when photographing the farm field 500 are calculated and transmitted to the drone 24.

### [A-2-4. Growth Assessment Model Calibration Management Control]

### (A-2-4-1. Outline)

As described above, the growth assessment model calibration management control (hereinafter also referred to as “calibration management control”) is control for calibrating the growth assessment model, and is mainly executed by the growth assessment server 22 (mainly the growth assessment unit 62). The calibration of the growth assessment model here includes calibration (or correction) of a parameter of the growth assessment model based on a detected value calculated on the basis of an image of the farm field 500 (or the crop 502) acquired by the drone 24.

The calibration management control includes calibration schedule management control and calibration execution control. The calibration schedule management control (hereinafter also referred to as “schedule management control”) is control that manages the execution timing of the calibration. The calibration execution control is control for executing the calibration of the growth assessment model in accordance with execution timing or the like set by the schedule management control.

### (A-2-4-2. Calibration Schedule Management Control)

### (A-2-4-2-1. Overall Flow)

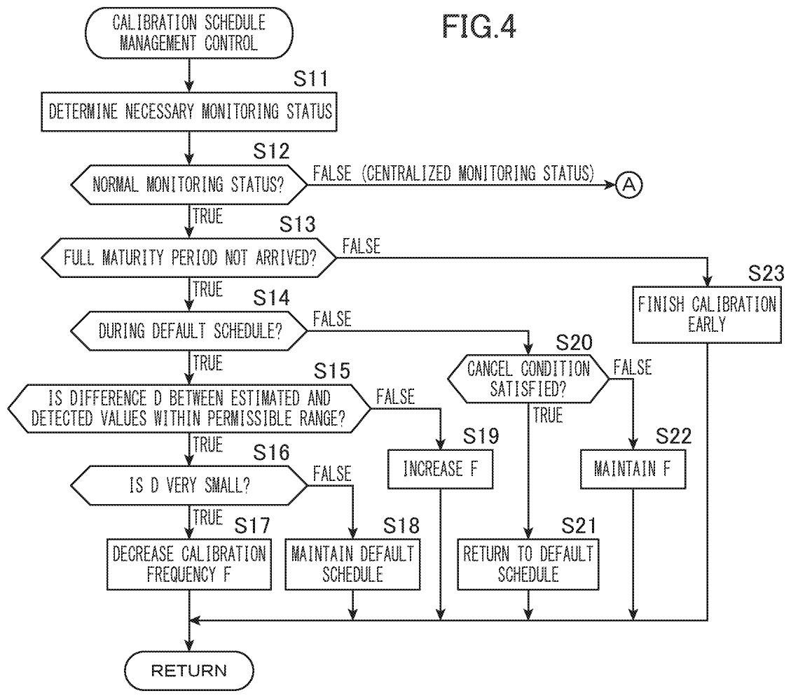

FIG. 4 and FIG. 5 are first and second flowcharts showing the calibration schedule management control in the present embodiment. As described above, the schedule management control is control for managing the execution timing of the calibration. In the schedule management control of the present embodiment, schedule management in accordance with the growth phase or the like of the crop 502 and schedule management associated with the change of the parameter of the growth assessment model at the time of execution of the calibration are performed. In the present embodiment, the schedule management control and the calibration execution control are performed for each farm field 500.

In step S11 of FIG. 4, the growth assessment server 22 determines a current necessary monitoring status (necessary monitoring status). The necessary monitoring status includes a normal monitoring status in which normal monitoring is performed and a centralized monitoring status in which centralized monitoring is performed. The centralized monitoring status is a status in which the frequency of the calibration (frequency F) is increased because the change in the growth state of the crop 502 is large.

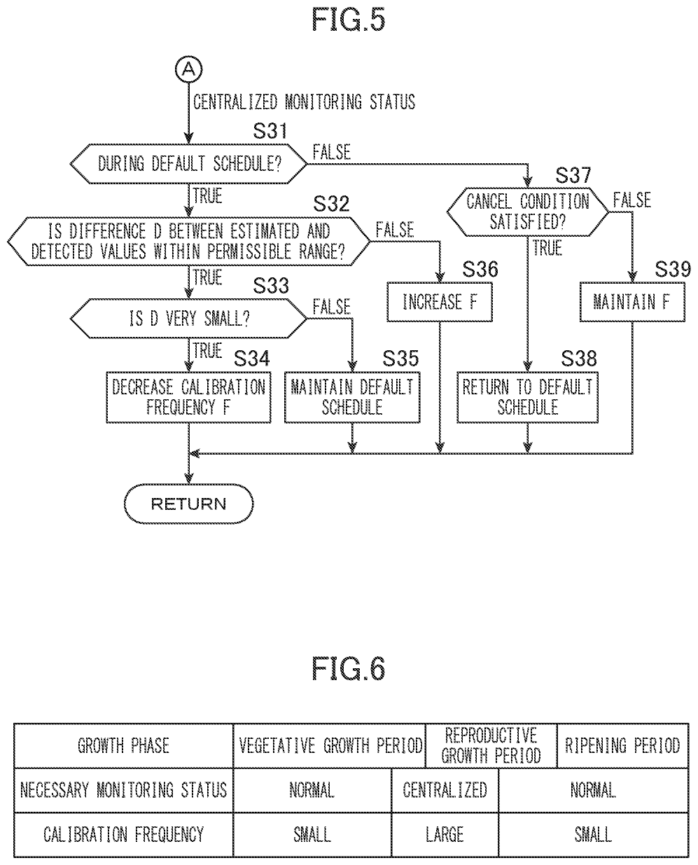

The centralized monitoring status includes, for example, the transition time of the growth phase of the crop 502, before and after fertilization, and the timing when the growth state value V of the crop 502 (estimated growth state value Ve, etc.) greatly deviate from a target value (target growth state value Vt), the timing when the temperature deviates from the average temperature or the average amount of solar radiation throughout the year (for example, when the temperature continues to be 35 degree Celsius or higher), the timing of fertilizer absorption and changes in the amount of nitrogen in the soil. The transition time of the growth phase will be described later with reference to FIG. 6. A threshold for determining whether the difference between the estimated growth state value Ve or the like and the target growth state value Vt is large or not (growth failure determination threshold THvd) can be switched for each growth phase of the crop 502. A threshold for determining whether the deviation from the average temperature for the whole year is large or not (temperature deviation determination threshold THt) and a threshold for determining whether the deviation from the average amount of solar radiation for the whole year is large or not (solar radiation amount deviation determination threshold THs) can be switched for each growth phase of the crop 502.

The normal monitoring status is a status other than the centralized monitoring status during the calibration target period.

In step S12 of FIG. 4, the growth assessment server 22 determines whether the current necessary monitoring status is the normal monitoring status or not based on the determination result of step S11. If the current necessary monitoring status is the normal monitoring status (S12: TRUE), the process proceeds to step S13.

In step S13, the assessment server 22 determines whether the full maturity period (or harvesting period) of the crop 502 has not arrived. This determination is made on the basis of whether or not, for example, the measured yield Qm of the crop 502 or the measured waste rice ratio Rm at the target time has been input for the target field 500. If the fully maturity period of the crop 502 has not arrived (S13: TRUE), the process proceeds to step S14.

In step S14, the assessment server 22 determines whether the current calibration schedule is a default (initial) schedule for the normal monitoring status. In other words, the assessment server 22 determines whether the state in which the schedule has been changed in step S17 or S19 for the previous schedule management control is maintained. This determination can be made, for example, by confirming a value of a flag indicating whether the schedule has been changed or not. If it is the default schedule for the normal monitoring status (S14: TRUE), the process proceeds to step S15.

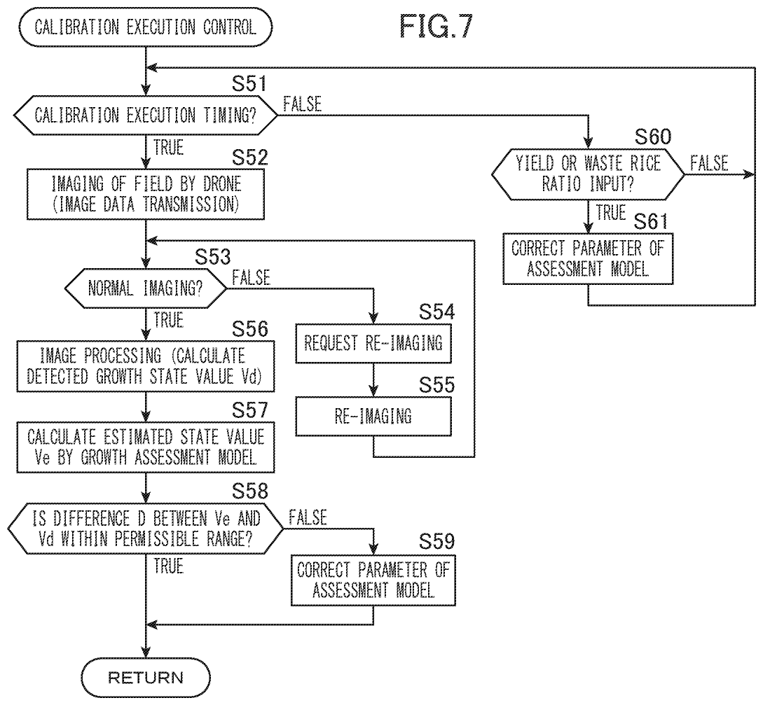

In step S15, the assessment server 22 determines whether a difference D is within a permissible range or not, where the difference D is a difference between a growth state value of the crop 502 calculated by the growth assessment model (hereinafter referred to as “estimated growth state value Ve” or “estimated value Ve”) and a growth state value of the crop 502 calculated based on the farm field image (hereinafter referred to as “detected growth state value Vd” or “detected value Vd”). In other words, it is determined whether the absolute value of the difference D is equal to or less than a first frequency determination difference threshold THfm1. The first frequency determination difference threshold THfm1 can use the same value as a difference threshold THd (S58 in FIG. 7) which will be described later. The calculation method, type, etc. of the estimated value Ve and the detected value Vd will be described later in relation to steps S56 and S57 of FIG. 7. If the difference D is within the permissible range (S15: TRUE), the process proceeds to step S16.

In step S16, the assessment server 22 determines whether the difference D is very small (in other words, whether the difference D within the permissible range is a smaller value among them). In other words, it is determined whether the absolute value of the difference D is equal to or less than a second frequency determination difference threshold THfm2. If the difference D is very small (S16: TRUE), it can be considered that the parameters of the growth assessment model are very effective values. Therefore, in step S17, the assessment server 22 lowers the calibration frequency F from the default schedule. For example, according to the default schedule under the normal monitoring status, the calibration is performed once a month. On the other hand, as the result of step S17, the assessment server 22 changes the schedule to perform the calibration once every 1.5 months.

Returning to step S16, if the difference D is not very small (S16: FALSE), in step S18, the assessment server 22 maintains the default schedule for the normal monitoring status.

Returning to step S15, if the difference D is not within the permissible range (S15: FALSE), the reliability of the parameters of the growth assessment model may be low. Therefore, in step S19, the assessment server 22 increases the calibration frequency F more than the default schedule for the normal monitoring status. For example, according to the default schedule under the normal monitoring status, the calibration is performed once a month. On the other hand, as the result of step S19, the assessment server 22 changes the schedule to perform the calibration once every 0.5 months.

Returning to step S14, if the current calibration schedule is not the default schedule for the normal monitoring status (S14: FALSE), the current calibration schedule is the schedule changed from the default schedule in step S17 or S19. In that case, the process proceeds to step S20.

In step S20, the assessment server 22 determines whether a condition for canceling the schedule change is satisfied. For example, when the calibration frequency F has been reduced in step S17, it is determined whether the absolute value of the difference D exceeds a threshold (first cancel threshold THfr1) for canceling the decrease in the frequency F. If the absolute value of the difference D exceeds the first cancel threshold THfr1, it is determined that the cancel condition is satisfied. Further, when the calibration frequency F has been increased in step S19, it is determined whether the absolute value of the difference D is below a threshold (second cancel threshold THfr2) for canceling the increase in the frequency F. If the absolute value of the difference D is less than the second cancel threshold THfr2, it is determined that the cancel condition is satisfied.

If the condition for canceling the schedule change is satisfied (S20: TRUE), in step S21, the assessment server 22 returns the schedule to the default schedule for the normal monitoring status. If the condition for canceling the schedule change is not satisfied (S20: FALSE), in step S22, the assessment server 22 maintains the current schedule (the schedule changed from the default schedule for the normal monitoring status). In other words, the assessment server 22 maintains the current calibration frequency F.

Returning to step S13, if the full maturity period of the crop 502 has already arrived (S13: FALSE), it can be said that the need for the calibration for the current growth has disappeared. Therefore, in step S23, the assessment server 22 finishes the calibration early.

Returning to step S12, if the current necessary monitoring status is not the normal monitoring status (S12: FALSE), the current necessary monitoring status is the centralized monitoring status. In that case, the process proceeds to step S31 of FIG. 5. Steps S31 to S39 in FIG. 5 are basically similar to steps S14 to S22 in FIG. 4. However, steps S14 to S22 in FIG. 4 are based on the normal monitoring status, while steps S31 to S39 in FIG. 5 are based on the centralized monitoring status. Therefore, the thresholds or the like in each step may be made different from those of FIG. 4.

Specifically, in step S31, the assessment server 22 determines whether the current calibration schedule is the default schedule for the centralized monitoring status. In other words, the assessment server 22 determines whether the state in which the schedule has been changed in step S34 or S36 for the previous schedule management control is maintained. If it is the default schedule for the centralized monitoring status (S31: TRUE), the process proceeds to step S32.

In step S32, the assessment server 22 determines whether the difference D is within a permissible range, where the difference D is a difference between the estimated growth state value Ve (estimated value Ve) calculated by the growth assessment model and the detected growth state value Vd (detected value Vd) based on the drone image. In other words, it is determined whether the absolute value of the difference D is equal to or less than the first frequency determination difference threshold THfm1. If the difference D is within the permissible range (S32: TRUE), the process proceeds to step S33.

In step S33, the assessment server 22 determines whether the difference D is very small (in other words, whether the difference D within the permissible range is a smaller value among them). In other words, it is determined whether the absolute value of the difference D is equal to or less than the second frequency determination difference threshold THfm2. If the difference D is very small (S33: TRUE), in step S34, the assessment server 22 lowers the calibration frequency F from the default schedule for the centralized monitoring status. For example, according to the default schedule for the centralized monitoring status, the calibration is performed once a week. On the other hand, as the result of step S34, the assessment server 22 changes the schedule to perform the calibration once every two weeks.

Returning to step S33, if the difference D is not very small (S33: FALSE), in step S35, the assessment server 22 maintains the default schedule for the centralized monitoring status.

Returning to step S32, if the difference D is not within the permissible range (S32: FALSE), in step S36, the assessment server 22 increases the calibration frequency F more than the default schedule for the centralized monitoring status. For example, according to the default schedule for the centralized monitoring status, the calibration is performed once a week. On the other hand, as the result of step S36, the assessment server 22 changes the schedule to perform the calibration once every three days.

Returning to step S31, if the current calibration schedule is not the default schedule for the centralized monitoring status (S31: FALSE), the current calibration schedule is the schedule changed from the default schedule in step S34 or S36. In that case, the process proceeds to step S37.

In step S37, the assessment server 22 determines whether the condition for canceling the schedule change is satisfied. For example, when the calibration frequency F has been reduced in step S34, it is determined whether the absolute value of the difference D exceeds the threshold for canceling the decrease in the frequency F (first release threshold THfr1). If the absolute value of the difference D exceeds the first cancel threshold THfr1, it is determined that the cancel condition is satisfied. Further, when the calibration frequency F has been increased in step S36, it is determined whether the absolute value of the difference D is below the threshold for canceling the increase in the frequency F (second cancel threshold Thfr2). If the absolute value of the difference D is less than the second cancel threshold THfr2, it is determined that the cancel condition is satisfied.

If the condition for canceling the schedule change is satisfied (S37: TRUE), in step S38, the assessment server 22 returns the schedule to the default schedule for the centralized monitoring status. If the condition for canceling the schedule change is not satisfied (S37: FALSE), in step S39, the assessment server 22 maintains the current schedule (the schedule changed from the default schedule for the centralized monitoring status). In other words, the assessment server 22 maintains the current calibration frequency F.

### (A-2-4-2-2. Determination of Necessary Monitoring Status (S11 in FIG. 4))

FIG. 6 is an explanatory diagram for explaining a determination method of the necessary monitoring status in the present embodiment. In FIG. 6, the relationship among the growth phases of the crop 502, the necessary monitoring status, and the calibration frequency F is shown.

The growth phases include a vegetative growth period, a reproductive growth period, and a ripening period. The vegetative growth period is a period from germination to the formation of the bases of ears (primordia of ears). The reproductive growth period is a period from the formation of the primordia of the ears to the heading (external ear emergence) or flowering. The ripening period is a period from the heading or the flowering to maturation.

As shown in FIG. 6, in the present embodiment, the necessary monitoring status is set as the centralized monitoring status during transition from the vegetative growth period to the reproductive growth period, and the other periods are set as the normal monitoring status.

As described above, the determination of the necessary monitoring status (S11 in FIG. 4) is made based on not only the growth phase, but also other factors (for example, fertilization timing, deviation from the year-round average temperature or the average solar radiation, the absorption timing of the fertilizer, and the change in the amount of nitrogen in the soil). For example, even if the growth phase is not during the transition from the vegetative growth period to the reproductive growth period, the centralized monitoring status is selected, for example, before and after fertilization, in abnormal weather, or the like.

### (A-2-4-3. Calibration Execution Control)

FIG. 7 is a flowchart of calibration execution control in the present embodiment. As described above, the calibration execution control is control for executing the calibration of the growth assessment model according to the execution timing or the like set in the schedule management control.

In step S51 of FIG. 7, the growth assessment server 22 (schedule management unit 80) determines whether the calibration execution timing by the calibration schedule management control has arrived. This determination is performed for each farm field 500 managed by the assessment server 22. If the calibration execution timing has arrived (S51: TRUE), the process proceeds to step S52.

In step S52, the assessment server 22 requests the drone 24 to photograph the field 500 for calibration. Specifically, the assessment server 22 causes the display unit (touch panel or the like) of the first user terminal 26 or the like to display the work instruction. The user 600 who sees this work instruction operates the first user terminal 26 to capture images of the target field 500 by the drone 24. The image data acquired by the drone 24 is immediately transmitted to the assessment server 22. Alternatively, the image data may be collectively transmitted after the end of the photographing.

In step S53, the assessment server 22 determines whether the imaging of the drone 24 has been performed normally. For example, the assessment server 22 determines whether the detected illuminance of the same portion of the field image is a fixed value continuously for a predetermined time or longer. By this determination, it is possible to determine whether dirt adheres to the imaging portion of the camera 120. Further, the assessment server 22 can determine that the imaging is defective when the illuminance of the entire field image is too weak or too strong. For example, it is determined whether an area (or the number of pixels) of the halation region in the field image is equal to or larger than a threshold for determining imaging failures (imaging failure threshold). The halation region indicates a region where the brightness of the pixel is the maximum value (255 in the case of 8 bits).

The determination in step S53 is performed for each farm field 500. Alternatively, the determination in step S53 may be performed for each partial region included in the field 500. If it is determined that the imaging of the drone 24 is normal (S53: TRUE), the process proceeds to step S56.

On the other hand, if it is determined that the imaging of the drone 24 is not normal (S53: FALSE), in step S54, the assessment server 22 requests re-imaging by the drone 24. Specifically, the re-imaging request unit 74 requests re-imaging in a time zone different from the previous imaging (S54). For example, it is required to perform re-photographing after the lapse of 30 minutes or more from the previous photographing. When the imaging date is made different, the time shifted by ±30 minutes or more with respect to the imaging time of the previous imaging may be used. Alternatively, different solar altitude (for example, ±3.8 degrees or more) may be used instead of the different time zone. The request is displayed on the display unit of the first user terminal 26, for example.

Alternatively, the re-imaging requesting unit 74 may request re-imaging in a direction in which the relative positional relationship between the drone 24 and the sun is different from the previous imaging. Thereby, it is possible to cope with the case where the previous photographing is performed in the backlight state. Alternatively, the re-imaging request unit 74 may request re-imaging in a different weather from the previous imaging. For example, if the previous imaging is performed in fine weather, it may be required to perform re-imaging in cloudy weather. Alternatively, the re-imaging request unit 74 may request re-imaging in a direction in which the relative positional relationship between the drone 24 and the field 500 is different from the previous imaging. For example, if the previous imaging was performed in a direction along the interrows of the field 500, the re-imaging may be requested to be performed in a direction perpendicular to the interrows or in an oblique direction with respect to the interrows.

When the determination of the imaging failure is performed for each farm field 500 or every partial region thereof, the target of the re-imaging can be the same field 500. Further, when the determination of the imaging failure is performed for each partial region of the field 500, the target of the re-imaging may be the same partial region.

In step S55, the user 600 who has received the work instruction for re-imaging operates the first user terminal 26 to perform re-imaging with the drone 24 on the target field 500. After step S55, the process returns to step S53.

In step S56, the assessment server 22 processes the image data received from the drone 24 to calculate the growth state value V (detected growth state value Vd) of the crop 502. For example, when the near-infrared light (NIR) and the infrared light (IR) of paddy rice as the crop 502 are captured, the growth degree of the paddy rice can be determined on the basis of red light absorbing ratio that is the ratio of difference between the amount of near-infrared light and the amount of infrared light received by the camera 120 relative to the total amount of light (that is, the ratio of the red light absorbed by the crop 502).

The type of the detected growth state value Vd calculated here can be selected in accordance with the growth phase (FIG. 6). In the vegetative growth period, for example, the height of the crop 502, the number of leaves, the red light absorbing ratio, the effective light receiving area ratio (area ratio of the leaves capable of performing photosynthesis in the field area), NDVI (Normalized Difference Vegetation Index), the number of divisions (tillering), the height of the leaves, and density of the crop 502 (area ratio between the soil and the crop 502) can be used. In the reproductive growth period, for example, the height of the crop 502, the number of leaves, the effective light receiving area ratio, and the NDVI can be used. In the ripening period, for example, the number of grains and the NDVI can be used.

In step S57, the assessment server 22 calculates the growth state value V (estimated growth state value Ve) of the crop 502 based on the growth assessment model. Since the estimated growth state value Ve calculated here is used for comparison with the detected growth state value Vd, a value of the same type as the detected growth state value Vd calculated in step S56 is calculated.

In step S58, the assessment server 22 determines whether the difference D between the estimated growth state value Ve and the detected growth state value Vd is within the permissible range. In other words, it is determined whether the absolute value of the difference D is equal to or less than the difference threshold THd. For example, the permissible range corresponding to the type of the growth state value V (such as the number of grains) as described above with respect to step S56 is set, and it is determined whether the difference D is within the permissible range. When the growth state value V to be compared in step S58 is the yield Q and the measured yield Qm has been input for or before the previous term, the measured yield Qm may be used in preference to the yield Q as the detected value Vd (detected yield Qd). The same applies to a case where the measured waste rice ratio Rm has been input for or before the previous term.

If the difference D is within the permissible range (S58: TRUE), it is considered that the growth assessment model is functioning normally. Therefore, the calibration execution control this time is terminated. If the difference D is not within the permissible range (S58: FALSE), it is considered that there is a problem in the parameter (coefficient or default value) of the growth assessment model. In that case, the process proceeds to step S59.

In step S59, the assessment server 22 corrects the parameters of the growth assessment model. For example, the inclination “a” at the formula 3 ([0057]) of JP2015-000049A may be changed by a predetermined amount so that the estimated value Ve approaches the detected value Vd.

Returning to step S51, if the calibration execution timing by the calibration schedule management control has not arrived (S51: FALSE), the process proceeds to step S60. In step S60, the assessment server 22 determines whether the yield Q by the yield sensor 32 (measured yield Qm) or the waste rice ratio R by the rice grader 34 (measured waste rice ratio Rm) has been input or not.

If the measured yield Qm or the measured waste rice ratio Rm has been input (S60: TRUE), in step S61, the assessment server 22 corrects the parameters of the growth assessment model using the input measured yield Qm or the input measured waste rice ratio Rm. For example, the model parameter is corrected so as to bring the yield Q as the current estimated value Ve (estimated yield Qe) close to the input yield Q (measured yield Qm). Similarly, the model parameter is corrected so as to bring the waste rice ratio R as the current estimated value Ve (estimated waste rice ratio Re) close to the input waste rice ratio R (measured waste rice ratio Rm).

As described above, since the drone image is transmitted immediately after shooting, the steps in FIG. 7 may be performed in parallel.

### <A-3. Effects of the Present Embodiment>

According to the present embodiment, the growth assessment model is corrected by comparing the estimated growth state value Ve calculated by the growth assessment model with the detected growth state value Vd based on the image of the farm field 500 acquired by the camera 120 (S56 to S59 in FIG. 7). Thereby, it is possible to perform the growth assessment according to the characteristics of each farm field 500 with the accuracy according to the reliability of the detected growth state value Vd based on the image of the farm field 500. Further, by using the image of the farm field 500, it is possible to easily perform the growth assessment according to the characteristics of each farm field 500.

In the present embodiment, the growth state value V of the crop 502 includes the number of grains of the rice (or rice hulls). The model correction unit 84 corrects the growth assessment model (S59 in FIG. 7) if the difference D between the estimated number of grains of the crop 20 calculated by the growth assessment model and the detected number of grains of the crop 20 calculated based on the image of the drone 24 exceeds the difference threshold THd (first difference threshold) (S58: FALSE in FIG. 7). Thus, only when the necessity of correcting the growth assessment model is high, the correction can be performed.

In the present embodiment, the growth assessment system 10 further includes the imaging failure determination unit 81 (FIG. 2) that determines whether there is an imaging failure by the camera 120 based on the image of the farm field 500. Further, the image processing unit 82 (detected state value calculation unit) calculates the detected growth state value Vd (S56 in FIG. 7) as the growth state value of the crop 502 based on the image of the farm field 500 that the imaging failure determination unit 81 has determined there is no imaging failure (S53: TRUE in FIG. 7). Thereby, it is possible to use the detected growth state value Vd only when there is no imaging failure (that is, when the imaging is normal).

In the present embodiment, the growth assessment system 10 further includes the re-imaging request unit 74 (FIG. 2) that requests re-imaging by the camera 120 (S54 in FIG. 7) when the imaging failure determination unit 81 determines that the imaging failure has occurred (S53: FALSE in FIG. 7). Thereby, the reliability of the growth assessment model can be improved by improving the accuracy of the detected growth state value Vd by re-imaging.

In the present embodiment, the imaging failure determination unit 81 determines whether there is the imaging failure for each farm field 500 or for each partial region included in the farm field 500 (S53 in FIG. 7). Further, the re-imaging request unit 74 requests the re-imaging (S54) for the farm field 500 in which the imaging failure has occurred when occurrence of the imaging failure has been determined (S53: FALSE). Thereby, it is possible to re-acquire the detected growth state value Ve in units of farm fields 500.

Further, in the case where the imaging failure determination unit 81 determines whether there is the imaging failure for each partial region included in the farm field 500 and it is determined that there is the imaging failure, the re-imaging request unit 74 may request the re-imaging for the partial region in which the imaging failure has occurred. Thereby, it is possible to reduce the man-hours by performing re-imaging only for the partial region in which the imaging failure has occurred.

In the present embodiment, if the imaging failure determination unit 81 determines that the imaging failure has occurred (S53: FALSE in FIG. 7), the re-imaging request unit 74 requests the re-imaging at the time zone or a solar height different from the previous imaging (S54). Alternatively, the re-imaging request unit 74 requests the re-imaging in the direction different from the previous imaging in the relative positional relationship between the drone 24 and the sun. Alternatively, the re-imaging request unit 74 requests the re-imaging in the weather different from the previous imaging. Alternatively, the re-imaging request unit 74 requests the re-imaging in the direction different from the previous imaging in the relative positional relationship between the camera 120 and the farm field 500. In either case, it is possible to reduce the possibility of re-occurrence of the imaging failure.

In the present embodiment, if the difference determination unit 83 determines that the absolute value of the difference D between the estimated growth state value Ve and the detected growth state value Vd exceeds the difference threshold THd (first difference threshold) (S58: FALSE in FIG. 7), the model correction unit 84 corrects the parameter of the growth assessment model (S59). Thereby, when the cause of the difference between the estimated growth state value Ve and the detected growth state value Vd is in the parameter of the growth assessment model, the growth assessment model can be more preferably corrected.

In the present embodiment, the growth assessment system 10 further includes the drone 24 on which the camera 120 is mounted, and the schedule management unit 80 that manages the schedule of imaging by the drone 24 for comparison between the estimated growth state value Ve and the detected growth state value Vd (FIG. 2 and FIG. 3). If the difference determination unit 83 determines that the absolute value of the difference D between the estimated growth state value Ve and the detected growth state value Vd exceeds the first frequency determination difference threshold THfm1 (=difference threshold THd (first difference threshold) (S15: FALSE in FIG. 4 or S32: FALSE in FIG. 5), the schedule management unit 80 adds the new imaging schedule before the next imaging of the initial plan or make the next imaging earlier than the initial plan (S19 in FIG. 4 or S36 in FIG. 5). Thereby, it is possible to relatively early reconfirm whether there is no difference between the estimated growth state value Ve and the detected growth state value Vd, in other words, whether the reliability of the growth assessment model is high.

In the present embodiment, if the difference determination unit 83 has determined that the absolute value of the difference D between the estimated growth state value Ve and the detected growth state value Vd exceeds the first frequency determination difference threshold THfm1 (=difference threshold THd (first difference threshold)) (S15: FALSE in FIG. 4 or S32: FALSE in FIG. 5) and then the difference D falls below the second cancel threshold THfr2 (second difference threshold) (S20: TRUE in FIG. 4 or S37: TRUE in FIG. 5), the schedule management unit 80 returns the schedule of the imaging to the initial plan (S21 in FIGS. 4 and S38 in FIG. 5). Thereby, when it can be determined that the absolute value of the difference D between the estimated growth state value Ve and the detected growth state value Vd becomes sufficiently small, in other words, when it can be determined that the reliability of the growth assessment model becomes sufficiently high, the imaging timing of the drone 24 can be delayed.

In the present embodiment, if the absolute value of the difference D between the estimated growth state value Ve and the detected growth state value Vd is lower than the second frequency determination difference threshold THfm2 (third difference threshold) (S16: TRUE in FIG. 4 or S33: TRUE in FIG. 5) and the growth of the crop 502 is as planned or earlier than planned, the schedule management unit 80 reduces the number of times of imaging than the initial plan (S17 in FIG. 4 or S34 in FIG. 5). Thereby, when it can be determined that the difference D between the estimated growth state value Ve and the detected growth state value Vd is sufficiently small, in other words, when it can be determined that the reliability of the growth assessment model is sufficiently high, the imaging timing of the drone 24 can be delayed.

In the present embodiment, if the crop 502 matures earlier than planned (S13: FALSE in FIG. 4), the schedule management unit 80 advances the timing of the final imaging (S23). Thereby, it possible to avoid imaging at an unnecessary timing.

In the present embodiment, the schedule management unit 80 increases the calibration frequency F (or frequency of the imaging by the drone 24) (S35 or S38 in FIG. 5 and FIG. 6) in the centralized monitoring status (S12: FALSE in FIG. 4) (or at the timing when the amount of change in the growth state value V of the crop 502 or the amount of change in the growth state value V of the crop 502 per unit period, or the absolute value of the growth state value V is larger than the first frequency threshold). Thereby, the reliability of the growth assessment system 10 can be easily confirmed in the centralized monitoring status.

In the present embodiment, the schedule management unit 80 lowers the calibration frequency F (frequency of the imaging by the drone 24) (S18 or S21 in FIG. 4) in the normal monitoring status (S12: FALSE in FIG. 4) (or at the timing when the absolute value of the growth state value V or the amount of the change in the growth state value V per unit period or the absolute value of the change amount of the growth state value V is smaller than the second frequency threshold). Thereby, it is possible to suppress the imaging frequency of the drone 24 in the normal monitoring status.

In the present embodiment, the schedule management unit 80 switches the thresholds used in the determination of the necessary monitoring status (such as the growth failure determination threshold THvd, the temperature deviation determination threshold THt and the solar radiation amount deviation determination threshold THs (first frequency determination thresholds and second frequency determination thresholds)) in accordance with the growth phase of the crop 502 (S11 in FIG. 4). Thereby, it is possible to switch the imaging frequency in accordance with the growth phase of the crop 502.

In the present embodiment, the imaging frequency F by the drone 24 at the transition period from the vegetative growth period to the reproductive growth period (or at the transition period of the growth phase of the crop 502) (transition-period frequency) is higher than the normal imaging frequency F at the period other than the transition period (normal frequency) (FIG. 6). Further, the maximum frequency at occurrence of the difference, which the schedule management unit 80 may set if the difference determination unit 83 determines the absolute value of the difference D between the estimated growth state value Ve and the detected growth state value Vd exceeds the first frequency determination difference threshold THfr1 (=difference threshold THd (first difference threshold)) (S32: FALSE in FIG. 5) is larger than the transition-period frequency (S35, S36 and S38 in FIG. 5). Thereby, it is possible to increase the imaging frequency when there is the difference between the estimated growth state value Ve and the detected growth state value Vd, and therefore to improve the reliability of the growth assessment system 10.

In the present embodiment, the growth assessment system 10 includes the yield sensor 32 that measures the yield Q of the harvested crop 502, and the third user terminal 30 (yield input unit) by which the measured value of the yield Q (measured yield Qm) is input (FIG. 1). Further, the estimated growth state value Ve includes the yield Q of the crop 502 calculated by the growth assessment model (estimated yield Qe), and the detected growth state value Vd includes the yield Q of the crop 502 calculated based on the image of the farm field 500 (detected yield Qd) (S56 and S57 in FIG. 7). If the measured yield Qm is input via the third user terminal 30 (S60: TRUE), the model correction unit 84 compares the measured yield Qm with the estimated yield Qe to correct the growth assessment model (S61).

Thereby, if the measured yield Qm is more accurate than the detected yield Qd, the reliability of the growth assessment system 10 can be improved by preferentially using the result of comparison between the measured yield Qm and the estimated yield Qe.

In the present embodiment, the growth assessment system 10 includes the rice grader 34 (waste rice ratio measuring device) that measures the waste rice ratio R of the harvested crop 502, and the third user terminal 30 (waste rice ratio input unit) by which the measured value of the waste rice ratio R (measured waste rice ratio Rm) is input (FIG. 1). The estimated growth state value Ve includes the waste rice ratio R calculated by the growth assessment model (estimated waste rice ratio Re), and the detected growth state value Vd includes the waste rice ratio R calculated based on the drone image (detected waste rice ratio Rd) (S56 and S57 in FIG. 7). If the measured waste rice ratio Rm is input via the third user terminal 30 (S60: TRUE), the model correction unit 84 compares the measured waste rice ratio Rm with the estimated waste rice ratio Re to correct the growth assessment model (S61).

Thereby, if the measured rice ratio Rm is more accurate than the detected waste rice ratio Rd, the reliability of the growth assessment system 10 can be improved by preferentially using the result of comparison between the measured waste rice ratio Rm and the estimated yield waste rice ratio Rd.

### B. Modifications

It should be noted that the present invention is not limited to the above-described embodiment, and it is needless to say that various configurations may be adopted based on the description of the present specification. For example, the following configurations can be employed.

### <B-1. Growth Assessment System 10>

The growth assessment system 10 of the above embodiment has the constituent elements as shown in FIG. 1. However, from the viewpoint of, for example, comparing the estimated growth state value Ve by the growth assessment model with the detected growth state value Vd based on the image of the farm field 500 or the crop 502 to correct the growth assessment model, the present invention is not limited thereto. For example, the growth assessment system 10 can omit one or more of the first user terminal 26, the second user terminal 28, the third user terminal 30, the yield sensor 32, the rice grader 34, and the information providing server 40.

In the above embodiment, the camera 120 that captures the field image is provided on the drone 24 (FIG. 3). However, from the viewpoint of, for example, comparing the estimated growth state value Ve by the growth assessment model with the detected growth state value Vd based on the image of the farm field 500 or the crop 502 to correct the growth assessment model, the present invention is not limited thereto. For example, the camera 120 that captures the image of the field 500 or the crop 502 may be fixedly arranged in the field 500. Alternatively, from the viewpoint of comparing the estimated growth state value Ve by the growth assessment model with the detected growth state value Vd based on the image of the crop 502 to correct the growth assessment model, the camera 120 may capture the image of the crop 502 at a place other than the field 500.

In the above embodiment, the growth assessment function (growth assessment unit 62) is provided in the growth assessment server 22 (FIG. 2). However, from the viewpoint of, for example, comparing the estimated growth state value Ve by the growth assessment model with the detected growth state value Vd based on the image of the farm field 500 or the crop 502 to correct the growth assessment model, the present invention is not limited thereto. For example, the function of the growth assessment may be given to the drone 24. Similarly, the calibration function of the growth assessment model may be provided in the drone 24.

In the above embodiment, wet-field rice (paddy rice) is used as the crop 502. However, from the viewpoint of, for example, comparing the estimated growth state value Ve by the growth assessment model with the detected growth state value Vd based on the image of the farm field 500 or the crop 502 to correct the growth assessment model, the present invention is not limited thereto. For example, the crop 502 may be upland rice, wheat, barley, soybean, or the like.

### <B-2. Calibration Control>

In the above embodiment, the timing for performing the calibration execution control is automatically set by the growth assessment server 22 (FIG. 4 and FIG. 5). However, from the viewpoint of, for example, comparing the estimated growth state value Ve by the growth assessment model with the detected growth state value Vd based on the image of the farm field 500 or the crop 502 to correct the growth assessment model, the present invention is not limited thereto. For example, the timing for performing the calibration execution control may be determined by the user 600.

In the above embodiment, the calibration frequency F is assumed three stages for the normal monitoring status (S17, S18 and S19 in FIG. 4). However, from the viewpoint of, for example, setting the frequency f in accordance with the reliability of the growth assessment model, the present invention is not limited thereto. For example, the frequency F in the normal monitoring status may be set to 2 stages or 4 or more stages. The same applies to the centralized monitoring status.

In the above embodiment, whether the difference D between the estimated growth state value Ve and the detected growth state value Vd is within the permissible range is determined by comparing the absolute value of the difference D with the difference threshold THd (first difference threshold) (S58 in FIG. 7). However, from the viewpoint of, for example, determining whether the difference D is within the permissible range or not, the present invention is not limited thereto. For example, whether the difference D is within the permissible range or not may be determined using whether the ratio of the difference D to the estimated growth state value Ve (or the detected growth state value Vd) is within thresholds. The same applies to steps S15, S16, S20 in FIG. 4, steps S32, S33, S37 in FIG. 5 or the like.

### <B-3. Others>

In the above embodiment, the flows shown in FIG. 4, FIG. 5 and FIG. 7 are used. However, for example, when the effect of the present invention is obtained, the contents of the flows (the order of each step) are not limited thereto. For example, the order of steps S52 and S56 and step S57 in FIG. 7 can be changed.

### DESCRIPTION OF REFERENCE CODE

10 growth assessment system
22 growth assessment server (growth assessment device)
24 drone
30 third user terminal (yield input unit, waste rice rate input unit)
32 yield sensor
34 rice grader (waste rice ratio measuring instrument)
72 re-imaging request unit
80 schedule management unit
81 imaging failure determination unit
82 image processing unit (detected growth state value calculation unit)
83 difference determination unit
84 model correction unit
120 camera
500 farm field
502 crop
D difference
Q yield
Qe estimated yield
Qm measured yield
R waste rice ratio
Re estimated waste rice ratio
Rm measured waste rice ratio
V growth state value
Vd detected growth state value
Ve estimated growth state value
THd difference threshold (first difference threshold)
THfm1 first frequency determination difference threshold (first difference threshold)
THfm2 second frequency determination difference threshold (third difference threshold)
THfr2 second cancel threshold (second difference threshold)
THs solar radiation amount deviation determination threshold (first frequency determination threshold, second frequency determination threshold)
THt temperature deviation determination threshold (first frequency determination threshold, second frequency determination threshold)
THvd growth failure determination threshold (first frequency determination threshold, second frequency determination threshold)

1. A growth assessment system, comprising:
a growth assessment device that assesses a growth state of a crop in a farm field using a growth assessment model;
a camera that acquires an image of the farm field;
a detected growth state value calculation unit that calculates a detected growth state value as a growth state value of the crop based on the image of the farm field;
a difference determination unit that compares the detected growth state value with an estimated growth state value that is a growth state value of the crop calculated by the growth assessment model; and
a model correction unit that corrects the growth assessment model in accordance with the comparison result by the difference determination unit.

2. The growth assessment system according to claim 1,
wherein the growth state value of the crop includes the number of grains of the crop, an effective light receiving area ratio which is an area ratio of leaves for photosynthesis in the farm field, a red light absorbing ratio which is a ratio of red light absorbed by the crop in the image of the farm field, an effective light receiving area obtained by multiplying the effective light receiving area ratio by a target area or a red light absorbing amount obtained by multiplying the red light absorbing ratio by the target area,
the model correction unit corrects the growth assessment model when an absolute value of difference or difference ratio exceeds a first difference threshold, the absolute value of the difference or the difference ratio including a difference between
the estimate number of grains of the crop, an estimated effective light receiving area ratio, an estimated red light absorbing ratio, an estimated effective light receiving area or an estimated red light absorbing amount that are calculated by the growth assessment model and
the detected number of grains of the crop, a detected effective light receiving area ratio, a detected red light absorbing ratio, a detected effective light receiving area or a detected red light absorbing amount that are calculated by the image of the farm field.

3. The growth assessment system according to claim 1,
wherein the growth assessment system further includes an imaging failure determination unit that determines whether there is an imaging failure by the camera based on the image of the farm field, and
wherein the detected state value calculation unit calculates the detected growth state value based on the image of the farm field that the imaging failure determination unit has determined there is no imaging failure.

4. The growth assessment system according to claim 3,
wherein the growth assessment system further includes a re-imaging request unit that requests re-imaging by the camera when the imaging failure determination unit has determined that the imaging failure has occurred.

5. The growth assessment system according to claim 4,
wherein the imaging failure determination unit determines whether there is the imaging failure for each farm field or for each partial region included in the farm field, and
wherein the re-imaging request unit requests the re-imaging for the farm field in which the imaging failure has occurred when occurrence of the imaging failure has been determined.

6. The growth assessment system according to claim 4,
wherein the imaging failure determination unit determines whether there is the imaging failure for each partial region included in the farm field, and
wherein if there is the imaging failure, the re-imaging request unit requests the re-imaging for the partial region in which the imaging failure has occurred.

7. The growth assessment system according to claim 4,
wherein if the imaging failure determination unit determines that the imaging failure has occurred, the re-imaging request unit requests the re-imaging at a time zone or at a solar height different from the previous imaging.

8. The growth assessment system according to claim 4,
wherein if the imaging failure determination unit determines that the imaging failure has occurred, the re-imaging request unit requests the re-imaging in a direction different from the previous imaging in a relative positional relationship between the camera and the sun.

9. The growth assessment system according to claim 4,
wherein if the imaging failure determination unit determines that the imaging failure has occurred, the re-imaging request unit requests the re-imaging in a weather different from the previous imaging.

10. The growth assessment system according to claim 4,
wherein if the imaging failure determination unit determines that the imaging failure has occurred, the re-imaging request unit requests the re-imaging in a direction different from the previous imaging in a relative positional relationship between the camera and the farm field.

11. The growth assessment system according to claim 2,
wherein if the absolute value of the difference or the ratio difference exceeds the first difference threshold, a parameter or a default value of the growth assessment model is corrected, the absolute value of the difference or the ratio difference including those between the estimated number of grains of the crop, the estimated effective light receiving area ratio, the estimated red light absorbing ratio, the estimated effective light receiving area or the estimated red light absorbing amount that are calculated by the growth assessment model, and the detected number of grains of the crop, the detected effective light receiving area ratio, the detected red light absorbing ratio, the detected effective light receiving area or the detected red light absorbing amount that are calculated by the image of the farm field.

12. The growth assessment system according to claim 11,
wherein the growth assessment system further includes:
a drone on which the camera is mounted, and
a schedule management unit that manages a schedule of imaging by the drone for comparison between the estimated growth state value and the detected growth state value, and
wherein if the difference determination unit determines that the absolute value of the ratio or the ratio difference between the estimated growth state value and the detected growth state value exceeds the first difference threshold, the schedule management unit adds a new imaging schedule before the next imaging of the initial plan or make the next imaging earlier than the initial plan.

13. The growth assessment system according to claim 12,
wherein if the absolute value of the difference or the difference ratio between the estimated growth state value and the detected growth state value falls below a second difference threshold after the absolute value of the difference or the difference ratio between the estimated growth state value and the detected growth state value exceeds the first difference threshold, the schedule management unit returns the schedule of the imaging to the initial plan.

14. The growth assessment system according to claim 12,
wherein if the difference between the estimated growth state value and the detected growth state value is lower than a third difference threshold and the growth of the crop is as planned or earlier than planned, the schedule management unit reduces the number of times of imaging than the initial plan.

15. The growth assessment system according to claim 12,
wherein if the crop matures earlier than planned, the schedule management unit advances the timing of the final imaging.

16. The growth assessment system according to claim 12,
wherein the schedule management unit increases the frequency of the imaging at a timing when the amount of change in the growth state value of the crop or the amount of change in the growth state value of the crop per unit period, or the absolute value of the growth state value is larger than a first frequency determination threshold.

17. The growth assessment system according to claim 16,
wherein the schedule management unit switches the first frequency determination threshold in accordance with the growth phase of the crop.

18. The growth assessment system according to claim 12,
wherein the schedule management unit lowers the frequency of the imaging at a timing when the amount of the change in the growth state value or the amount of the change in the growth state value per unit period or the absolute value of the change amount of the growth state value is smaller than a second frequency determination threshold.

19. The growth assessment system according to claim 18,
wherein the schedule management unit switches the second frequency determination threshold in accordance with the growth phase of the crop.

20. The growth assessment system according to claim 12,
wherein transition-period frequency, which is the imaging frequency by the drone at the transition period of the growth phase of the crop, is higher than normal frequency, which is normal value of the imaging frequency at a period other than the transition period of the growth phase of the crop, and
wherein maximum frequency at occurrence of difference, which the schedule management unit sets if the difference determination unit determines the absolute value of the difference or the difference ratio between the estimated growth state value and the detected growth state value has exceeded the first difference threshold, is larger than the transition-period frequency.

21. The growth assessment system according to claim 1,
wherein the growth assessment system includes:
a yield sensor that measures a yield as the number of grains or the weight of the harvested crop; and
a yield input unit by which a measured yield as the measured number of grains or the measured weight yield is input, and
wherein the estimated growth state value includes an estimated yield that is the number of grains or the weight of the crop calculated by the growth assessment model, and wherein if the measured yield is input via the yield input unit, the model correction unit compares the measured yield with the estimated yield to correct the growth assessment model.

22. The growth assessment system according to claim 1,
wherein the crop is rice,
wherein the growth assessment system further includes
a waste rice ratio measuring device that measures a ratio of immature rice contained in a unit amount of rice after harvesting, and
a waste rice ratio input unit by which a measured waste rice ratio, which is a measured value of the waste rice ratio, is input, and
wherein the estimated growth state value includes an estimated waste rice ratio that is a waste rice ratio calculated by the growth assessment model, and
wherein if the measured waste rice ratio is input via the waste rice ratio input unit, the model correction unit compares the measured waste rice ratio with the estimated waste rice ratio to correct the growth assessment model.

23. A growth assessment server that assesses a growth state of a crop by a growth assessment model, comprising:
a detected growth state value calculation unit that calculates a detected growth state value as a growth state value of the crop based on an image of the crop captured by a camera;
a difference determination unit that compares the detected growth state value with an estimated growth state value that is a growth state value of the crop calculated by the growth assessment model; and
a model correction unit that corrects the growth assessment model in accordance with the comparison result by the difference determination unit.

24. A growth assessment method for assessing a growth state of a crop by a growth assessment model, comprising:
a detected growth state value calculation step of calculating a detected growth state value as a growth state value of the crop based on an image of the crop captured by a camera;
a difference determination step of comparing the detected growth state value with an estimated growth state value that is a growth state value of the crop calculated by the growth assessment model; and
a model correction step of correcting the growth assessment model in accordance with the comparison result by the difference determination step.
